(19) United States
(12) Patent Application Publication
(10) Pub. No.: US 2009/0219968 A1
(43) Pub. Date: Sep. 3, 2009

(54) CONTROL SYSTEM FOR AN ARC FURNACE

(76) Inventors: Kevin Philippe Daniel Perry, Lisbon (PT); Theunis Johannes Vermeulen, Germiston (ZA)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/067,368

(22) PCT Filed: Sep. 12, 2006
(86) PCT No.: PCT/GB06/03357

§ 371 Date: Sep. 17, 2008

(30) Foreign Application Priority Data
Sep. 20, 2005 (GB) 0519163.0

(51) Int. Cl. H05B 7/148

(52) U.S. Cl. 373/104

(57) ABSTRACT

A control system for and method of controlling a vertical position of at least one electrode of an arc furnace, where the arc furnace comprises a furnace transformer having a primary, input side and a secondary, output side which is electrically connected to the at least one electrode, the control system comprising: at least one current-measuring device for measuring a current as drawn by the arc furnace; a voltage-measuring device for measuring a voltage as applied across the arc furnace; and a control unit for dynamically determining a setpoint for the vertical position of the at least one electrode based on the measured values of current and voltage, and providing an actuating output for driving a lifting arrangement to adjust the vertical position of the at least one electrode so as to follow the dynamically-determined setpoint.

The present invention relates to a control system for an arc furnace, an arc furnace which incorporates the same, and a method of controlling an arc furnace.

An arc furnace is an electric furnace in which the heat is produced by an electric arc between adjacent electrodes or between the electrodes and the furnace charge. The heat produced in this manner is used to heat and smelt the charge. Typically, the arm assembly, which carries the electrodes, weighs in the range of 2 to 50 tons, and is moved vertically for control purposes by a hydraulic cylinder or other actuator. Since the length of the electric arc depends, amongst other things, on the ever-changing level of charge, be it solid or liquid, under each electrode, it is necessary to control the positioning of the electrodes within the furnace.

The regulation system for controlling the positioning of the electrodes influences many important aspects of furnace performance, such as energy input, arc stability, solid charge melting pattern, and electrode consumption. All these parameters are interrelated in a complex manner and there are many differences of opinion on control strategies.

At present, one of the accepted regulation systems is one that aims to control the impedance of the electric arc produced by the electrodes. In particular, this system attempts to hold the ratio of voltage to electrical current constant. In use, a voltage signal taken from a phase from the power supply to ground, and a current signal are each separately measured and compared. If the voltage and current are each at a desired pre-selected setpoint, the output from this comparison of signals is arranged to be zero. If, however, the current exceeds its setpoint, which would simultaneously cause the voltage to decrease, a non-zero output signal is generated. This output signal causes the arm assembly to lift, thereby causing the electrodes to lift, which in turn reduces the current in order to maintain the impedance at a constant value.

In general, existing arc impedance regulators of the type described above are based on analogue electronics, with built-in drift and tolerance factors, leading to frequent recalibration requirements. Although some systems have turned to digital electronics to address these problems, these systems generally require large and expensive computing systems.

It would therefore be desirable to provide an arc furnace impedance regulator that addresses the above-mentioned problems in a cost-effective, and yet efficient, manner.

In one aspect the present invention provides a control system for controlling a vertical position of at least one electrode of an arc furnace, where the arc furnace comprises a furnace transformer having a primary, input side and a secondary, output side which is electrically connected to the at least one electrode, the control system comprising: at least one current-measuring device for measuring a current as drawn by the arc furnace; a voltage-measuring device for measuring a voltage as applied across the arc furnace; and a control unit for dynamically determining a setpoint for the vertical position of the at least one electrode based on the measured values of current and voltage, and providing an actuating output for driving a lifting arrangement to adjust the vertical position of the at least one electrode so as to follow the dynamically-determined setpoint.

Preferably, the at least one current-measuring device is operative to measure the current on one or both of the input and output sides of the furnace transformer.

In one embodiment the at least one current-measuring device comprises a first current-measuring device for measuring the current on the input side of the furnace transformer and a second current-measuring device for measuring the current on the output side of the furnace transformer.

Preferably, the voltage-measuring device is operative to measure the voltage between a bus of the furnace transformer and a furnace hearth.

Preferably, the control unit comprises a processor which is operative to run a control algorithm for dynamically determining a rate factor r, where r=x²/k, with x being a deviation in a setpoint value and k being a system-dependent constant, and provide the actuating output based on the dynamically-determined rate factor r.

In one embodiment x=n−p and p=(a/b)*(c/2), with n being a set point value, a being the current value as measured by the at least one current-measuring device, b being a rated secondary current value of the furnace transformer, and c being a count range of the processor.

In one embodiment k=Int((Tₘ*Eₜ/1000)/100)*100, with Tₘ being the melting point (liquidus) of the slag in degrees Kelvin and Eₜ being the total electrical energy required to drive the arc furnace in terms of kWh per metric ton of a charged material.

In one embodiment the processor is operative to provide a drive voltage v as the actuating output for driving the lifting arrangement.

In one embodiment v=(r/k)*(ABS(x)/x)*l, with l being a scale voltage for a drive unit of the lifting arrangement.

Preferably, the processor is a programmable logic controller (PLC).

The present invention also extends to an arc furnace comprising the above-described control system.

In its preferred embodiments the arc furnace is used in the smelting of materials, such as ore fines, or the melting of materials, such as metallic fines.

In another aspect the present invention provides a method of controlling a vertical position of at least one electrode of an arc furnace, where the arc furnace comprises a furnace transformer having a primary, input side and a secondary, output side which is electrically connected to the at least one electrode, the method comprising the steps of: measuring at least one current as drawn by the arc furnace; measuring a voltage as applied across the arc furnace; dynamically determining a setpoint for the vertical position of the at least one electrode based on the measured values of current and voltage; and providing an actuating output for driving a lifting arrangement to adjust the vertical position of the at least one electrode so as to follow the dynamically-determined setpoint.

Preferably, the current measuring step comprises the step of: measuring a current on one or both of the input and output sides of the furnace transformer.

In one embodiment the current measuring step comprises the steps of: measuring the current on the input side of the furnace transformer; and measuring the current on the output side of the furnace transformer.

Preferably, the voltage measuring step comprises the step of: measuring a voltage between a bus of the furnace transformer and a furnace hearth.

Preferably, the setpoint determining step comprises the step of: dynamically determining a rate factor r, where r=x²/k, with x being a deviation in a setpoint value and k being a system-dependent constant; and the actuating output providing step comprises the step of: providing an actuating output based on the dynamically-determined rate factor r for driving a lifting arrangement to adjust the vertical position of the at least one electrode so as to follow the dynamically-determined setpoint.

In one embodiment x=n−p and p=(a/b)*(c/2), with n being a set point value, a being the current value as measured by the at least one current-measuring device, b being a rated secondary current value of the furnace transformer, and c being a count range of the processor.

In one embodiment k=Int((Tₘ*Eₜ/1000)/100)*100, with Tₘ being the melting point (liquidus) of the slag in degrees Kelvin and Eₜ being the total electrical energy required to drive the arc furnace in terms of kWh per metric ton of a charged material.

In one embodiment the actuating output providing step comprises the step of: providing a drive voltage v as an actuating output for driving a lifting arrangement to adjust the vertical position of the at least one electrode so as to follow the dynamically-determined setpoint.

In one embodiment v=(r/k)*(ABS(x)/x)*l, with l being a scale voltage for a drive unit of the lifting arrangement.

In one embodiment the method is used in the smelting of materials, such as ore fines, or the melting of materials, such as metallic fines.

Advantages of the preferred embodiments of the present invention include:

### (1) Repeatability of Digital Processes

The impedance regulator is calibrated during commissioning and all control parameters are stored in non-volatile memory. Thus, the system only needs to be re-calibrated when system parameters change, such as when a different furnace transformer is installed.

### (2) Adaptive Power Control Feature

The input power is monitored and compared to the theoretical input power on the specific transformer tap. The result gives a good indication as to what the conditions in the furnace are like. The impedance regulator then adjusts the impedance setpoint to compensate for these conditions, thus ensuring that the power input is always as close to the theoretical optimum as possible. Because the arc furnace operates under this condition, it achieves better meltdown times, which also leads to better kWh/ton and electrode consumption figures.

### (3) Reduction in Electric Flicker

Electric flicker occurs when alternating current temporarily does not flow through the electrodes, and then suddenly begins to flow. This distortion of the current sine wave causes less power transfer into the metal, and more electrode wear. It also induces resonant oscillations back into the power grid. Typically, electricity suppliers require flicker to be controlled to within certain guidelines. If flicker is not kept to within these guidelines, the user is often severely fined. The impedance regulator of the present invention is in relative terms a far more stable system, which greatly assists in reducing flicker.

### (4) Reduced Wear

By achieving very precise control of the electric arc, it has been found that the present invention greatly reduces wear on the furnace as a whole, and in particular on the delta closures and walls of the furnace.

### (5) Production of Reports

The PLC of the present invention interfaces with a computer-based supervisory system that logs all the furnace operating parameters and graphically displays those parameters so that trends can be studied. The supervisory system also generates a manager's report consisting of all the alarms and events that were logged in a 24-hour period, as well as the maximum, minimum and average values in this period for furnace parameters, such as power and current.

### (6) User-Friendliness

The present invention is extremely user-friendly in requiring very little input from the operator to operate the furnace. Advantageously, the layout and presentation of the operating panels of the invention are similar to those used in more traditional arc furnaces, such as Amplidyne and Barnes. Thus, an operator who is familiar with any of these systems will require virtually no training at all to successfully operate the present invention.

### (7) Versatility

The high speed of the PLC, coupled with the versatility of the digital control algorithm, lends itself to a wider range of melting applications than the melting of scrap alone. With some adjustments to the gain and response parameters, the present invention can also be utilized for submerged arc processes as well as a combination of open arc and submerged arc processes, such as slag smelting and the smelting of ore fines to recover their contained metals. The present invention, for example, has been found to be extremely successful in recovering ferrovanadium from vanadium pentoxide, ferrochromium from chromite fines, cobalt from raw ores and slags, zinc from steel plant dusts, lead from blast furnace slags, and also in the re-melting of metallic fines, such as those containing, besides iron, vanadium, chromium and manganese.

In summary, a primary advantage of the present invention is in yielding the accuracy of digital systems, but at a lower cost due to the invention being implemented using standard, off the shelf PLC equipment. The present invention therefore represents a smaller and cheaper alternative to the existing systems.

A preferred embodiment of the present invention will now be described hereinbelow by way of example only with reference to the accompanying drawings, in which:

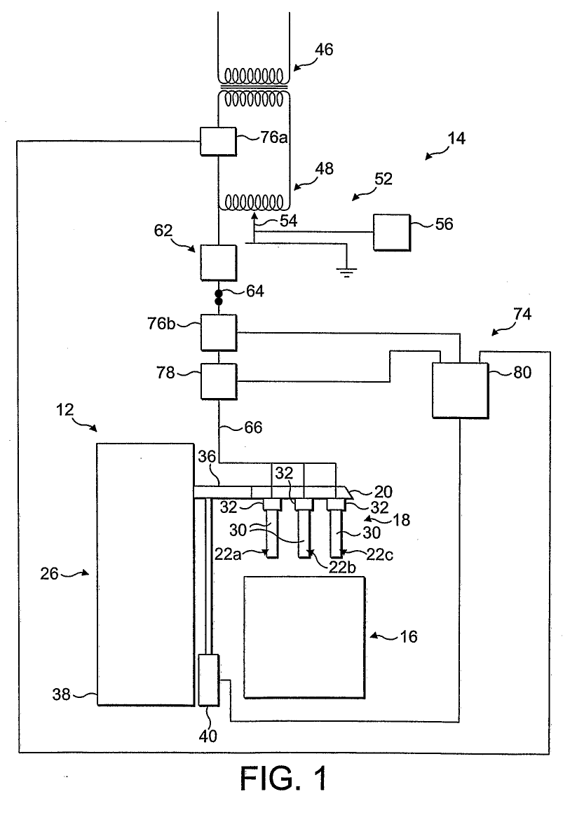

FIG. 1 schematically illustrates an arc furnace system incorporating an impedance regulator in accordance with a preferred embodiment of the present invention;

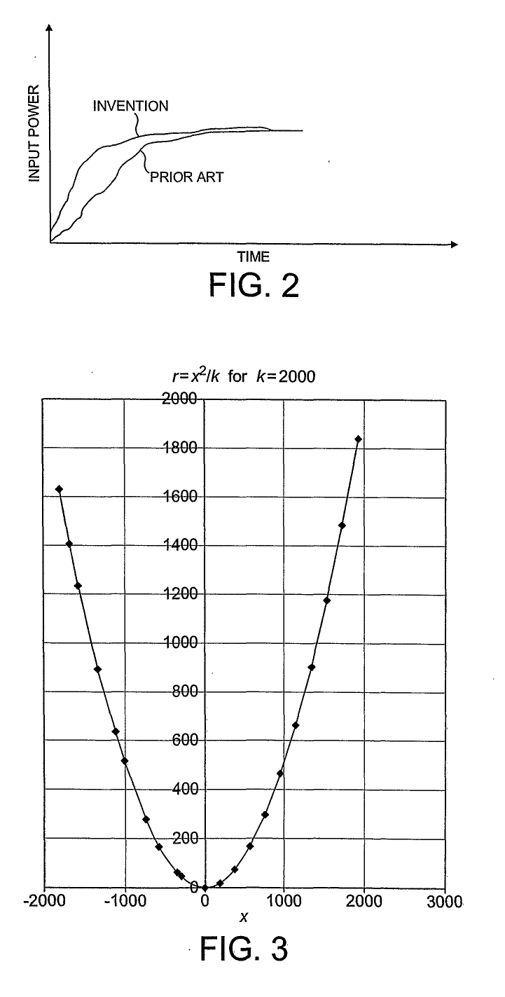

FIG. 2 is a graph illustrating comparative power profiles, on start-up, of an arc furnace utilizing the impedance regulator of the present invention and a conventional, prior art arc furnace; and

FIG. 3 illustrates a plot of the correction factor r, where r=x²/k, as employed in operation of the impedance regulator of the present invention.

The arc furnace system comprises an arc furnace 12 and an electrical supply system 14 for supplying electrical energy to the arc furnace 12.

The arc furnace 12 comprises a furnace shell 16 which contains material, typically in fine or granulated form, to be smelted or melted to provide a molten metallic phase, an electrode assembly 18 which, in operation, extends into the material as contained in the furnace shell 16, and a supporting unit 26 for movably supporting the electrode assembly 18 in relation to the furnace shell 16.

The electrode assembly 18 comprises a bus bar 20 and a plurality of, in this embodiment first to third electrode units 22a-c, which each comprise an electrode 30 and an electrode head 32 to which one, upper end of the electrode 30 is electrically and mechanically connected, in this embodiment through an electrode pad, where the mechanical connection is exposed to extreme mechanical conditions, including vibration and torsion.

The supporting unit 26 comprises a supporting arm 36 which extends over the furnace shell 16 and supports the electrode assembly 18, a supporting mast 38 to which the supporting arm 36 is vertically movably disposed, and a drive unit 40, in this embodiment a hydraulic unit, which is operable to raise and lower the supporting arm 36, and hence the electrode assembly 18 as supported thereby. Positioning of the electrodes 30 within the furnace shell 16 is essential, as this position determines inter alia the length of the electric arc. Typically, the combined weight of the electrode assembly 18 and the supporting arm 36 would be in the range of from about 2 to about 50 tons.

The electrical supply system 14 comprises a first, main transformer 46 which is electrically connected at an input side to a high-voltage supply as received from an electrical utility and at an output side provides a lower, intermediate voltage, typically between 30 and 33 kV, and a second, furnace transformer 48 which is electrically connected at an input side to the output side of the main transformer 46 and at an output side provides a still lower, furnace voltage at a high current, which is supplied to the electrode assembly 18, as will be described in more detail hereinbelow. In a typical arc furnace facility, the main transformer 46 would be electrically connected to a plurality of furnace transformers 48 of a plurality of arc furnaces 12.

In this embodiment the furnace transformer 48 includes a tap changer 52, which provides for the tapping of the furnace transformer 48 to provide for control of the furnace voltage to one of a plurality of predetermined voltages. This control of the furnace voltage, and the associated current, enables the arc furnace 12 to be operated with a range of arcs, each requiring a defined arc voltage and current.

In this embodiment the tap changer 52 comprises a tap 54 which is movable between one of a plurality of tap contacts along the primary winding at the input side of the furnace transformer 48, and a control unit 56, in this embodiment a motorized unit, for moving the tap 54 such as to be switched between the tap contacts as required.

The electrical supply system further comprises a delta closure 62 which comprises a plurality of connectors 64, in this embodiment copper terminal plates, which are electrically connected to the output side of the furnace transformer 48 and provide for electrical connection to furnace power cables 66 which are electrically connected to the bus bar 20 of the electrode assembly 18.

In this embodiment the transformers 46, 48 are located within a vault to ensure a clean, secure environment, and the delta closure 62 is located on a wall of the vault adjacent to the arc furnace 12.

The electrical supply system further comprises a control unit 74 for controlling the drive unit 40 of the support assembly 26 in vertically positioning the electrodes 30 of the electrode units 22a-c in the furnace shell 16.

The control unit 74 includes at least one current-measuring device 76 for measuring the current as drawn by the arc furnace 12, and a voltage-measuring device 78 for measuring the voltage as applied across the arc furnace 12.

In this embodiment the control unit 74 includes first and second current-measuring devices 76a, b, where the first current-measuring device 76a measures the current on the input side of the furnace transformer 48 and the second current-measuring device 76b measures the current on the output side of the furnace transformer 48.

In this embodiment the voltage-measuring device 78 measures the phase voltage between the bus of the furnace transformer 48 and the furnace shell 16.

The control unit 74 includes a programmable logic controller (PLC) 80 which is operatively connected to the at least one current-measuring device 76 and the voltage-measuring device 78 through respective analogue-to-digital (A-to-D) converters, which provide digital values which are representative of the measured analogue values of current and voltage, and the drive unit 40 of the support assembly 26 through a D-to-A converter, which provides an analogue signal to the drive unit 40 representative of the digital value corresponding to the determined rate of movement, such as thereby to enable control the position of the electrodes 30 of the electrode units 22-c within the furnace shell 16, and thus the arc as generated between the electrodes 30.

In this embodiment the PLC 80 is controlled via a closed-loop control algorithm. By ensuring that the response time of the PLC 80 at least matches the mechanical response time of the support assembly 26, high-speed and accurate control of the electrode assembly 18 is achieved, avoiding problems associated with unwanted resonance.

In this embodiment the PLC 80 utilizes a control algorithm based on a rate factor r, which represents the required rate of movement of the electrodes 30, as manifested by movement of the supporting arm 36 of the supporting assembly 26.

r=x²/k (1)

x=n−p (2)

p=(a/b)*(c/2) (3)

where:
k is a system-dependent constant;
n is a set point value;
a is the current value as measured by the at least one current-measuring device 76;
b is the rated secondary current value of the furnace transformer 48; and
c is the count range of the PLC 80.

The rate factor r is a mathematical correlation of actual data which was collected when operating arc furnaces of different sizes, namely, 450 kVA, 800 kVA, 1 MVA, 2 MVA and 3 MVA, when smelting ore fines and melting metallic fines.

In this embodiment an initial set point value nₗ is determined as follows.

nₗ=(d/b)*(c/2) (4)

where: d is the full load rated current of the arc furnace 12.

By way of example, for a step down transformer ratio d/b of 10/250 and where the PLC 80 has a count range of 4000, then employing Equation (4).

nₗ=(10/250)*(4000/2)
nₗ=80

Using this initial set point value nₗᵣ provides initially for stable operation of the arc furnace 12, and, during operation, the set point value n is altered in order to compensate for furnace conditions and thereby provides for optimization of the arc as generated between the electrodes 30 so as to input an optimum energy into the material in the furnace shell 16. In this embodiment the PLC 80 is operative to compare the actual power as input into the arc furnace 12, as determined from the values of voltage and current as measured by the at least one current-measuring device 76 and the at least one voltage-measuring device 78, with the power as should theoretically be achieved for the set tap 54 of the furnace transformer 48, and alter the set point value n as a function of this comparison.

In this embodiment the system-dependent constant k is initially accorded a calculated value, in order to provide initially for stable operation of the arc furnace 12.

The system-dependent constant k is determined as follows:

k=Int((Tₘ*Eₜ/1000)/100)*100 (5)

where:
Tₘ is the melting point (liquidus) of the introduced material in degrees Kelvin.
Eₜ is the total electrical energy required to drive the process in terms of kWh per metric ton of introduced material.

By way of example, for oxide materials, the melting point Tₘ and the total electrical energy Eₜ are determined as follows.

$${T}_{m} = 1189.157 + {C}_{0} \times ( 12.22238 + ( - 0.14321 \times {C}_{0} ) + ( 0.030606 \times {C}_{4} ) + ( 0.022817 \times {C}_{6} ) + ( - 0.54851 \times {C}_{5} ) + ( - 0.3636 \times {C}_{7} ) ) + {C}_{5} \times ( ( - 0.26564 \times {C}_{5} ) + ( 0.209113 \times {C}_{6} ) + ( - 1.13507 \times {C}_{7} ) + ( - 0.3511 \times {C}_{4} ) + ( 33.49343 ) ) + {C}_{4} \times ( - 6.53514 + ( 0.107294 \times {C}_{4} ) + ( - 0.35228 \times {C}_{7} ) ) + {C}_{6} \times ( ( - 18.8445 + ( 0.800383 \times {C}_{6} ) ) + {C}_{7} \times 38.97819$$

where:
C₀=% FeO×100×1.625/C_{S}
C₄=% SiO₂×200/C_{S}
C₅=% CaO×100/C_{S}
C₆=% MgO×100/C_{S}
C₇=(% Al₂O₃+% Cr₂O₃)×100/C_{S}
C_{S}=% FeO*1.625+% SiO₂+% CaO+% MgO+% Al₂O₃+% Cr₂O₃

Eₜ=(E_{O}+H_{React})/3.6/0.85

where:
E_{O} is the energy output in MJ.
H_{React} is heats of reaction in MJ, which represents the sum of the thermodynamic enthalpy change (ΔH_{295K}) associated with every reaction taking place in the process, with examples being:

ZnO+C═Zn+CO ΔH_{295K}=+237.551 kJ/mol C

FeO+C═Fe+CO ΔH_{295K}=+161.514 kJ/mol C.
The term 3.6 is the conversion factor for 3600 kJ, which corresponds to 1000 kWh.
The term 0.85 represents the efficiency factor for converting electrical energy into heat energy.
   The energy output E_{O} is determined as follows:

E_{O}=En_{Ga/Fu}+Enₛₗ+En_{Met}

### Where:

En_{Ga/Fu} is the energy value associated with the furnace off gas and fume.
En_{Sl} is the energy value associated with the furnace slag.
En_{Met} is the energy value associated with the molten metallic phase.

For example, for smelting a material producing a slag having a liquidus of 1345° C. and a power requirement of 957 kWh/t, following Equation (5), the system-dependent constant k is determined as follows.

k=Int(((1345+273)×(957/1000))/100)×100
k=1500

In one embodiment the PLC 80 is operative to adjust the system-dependent constant k, within a range of +/−5%, in order to optimize power usage, with the system-dependent constant k being influenced by inter alia the furnace size, the type of material being melted, the optimum operating temperature and the slag fluidity. Experimentation has, however, established that the system-dependent constant k usually has a value of between about 500 and about 3000, such that the optimal value of the system-dependent constant k is fairly rapidly determined.

In this embodiment the drive unit 40 of the supporting assembly 26 is actuated by an analogue drive voltage v which is output by the D-to-A converter of the PLC 80, with the scale of the drive voltage v determining the rate of movement of the drive unit 40, and the PLC 80 is operative to derive the control voltage v in accordance with the following output algorithm.

v=(r/k)*(ABS(x)/x)*l (6)
where: l is the scale voltage for the drive unit 40 of the supporting assembly 26.

The drive voltage v is one of a positive or negative voltage, in this embodiment with a positive voltage defining a vertically-downwards movement and a negative voltage defining a vertically-upwards movement.

By way of exemplification, FIG. 2 illustrates representative plots of the input power profile of a conventional arc furnace as compared to the input power profile of an arc furnace 12 as achieved by use of the control unit 74 of the present invention. These plots clearly illustrate the function of the control unit 74 in providing a greater energy input to the arc furnace 12.

Operation of the arc furnace system will now be described hereinbelow in the smelting of a batch of molten steel, which is known as a “heat”.

The furnace shell 16, where empty, is first charged with a small quantity, typically about 20 kg, of the material to be smelted.

The arc furnace 12 is then operated to smelt this material, which causes a small puddle of the molten product to form in the bottom of the bowl of the furnace shell 16.

Thereafter, more material is fed into the puddle of the molten product in the bowl of the furnace shell 16, where smelting is accomplished by supplying energy to the feed material as fed into the furnace shell 16. In this embodiment the feed material is fed continuously into the furnace shell 16 using a feeder, where the feed rate of the feeder matches the electrical energy as supplied by the electrodes 30. In preferred embodiments the feeder is one of a vibratory or belt feeder.

In this way, the small puddle of the molten product develops into a large pool of the molten product which fills the bowl of the furnace shell 16.

Although the energy required to drive the various reactions and produce various gaseous and liquid products can be electrical energy or chemical energy, where the chemical energy is supplied by at least one component, such as metallic silicon, which comprises part of the feed material, the electrical energy as supplied via the electrodes 30 is usually the largest contributor of energy in the smelting operations.

In this process, the electrode assembly 18 is lowered such that the electrodes 30 of the electrode units 22a-c strike an arc on the feed material, which starts the melting cycle, where the vertical position of the electrode assembly 18, and thus the electrodes 30 within the furnace shell 16, is controlled by the control unit 74 in the manner as defined hereinabove, in order to optimize operation of the arc furnace 12. Under such intelligent control, the secondary current, the arc length and the energy input are regulated. By controlling the vertical position of the electrodes 30 in this manner, electrode consumption, refractory wear, flicker, and total energy costs are all reduced, whilst furnace productivity and delta closure life are simultaneously increased.

Initially, the tap changer 52 of the electrical supply system is set such that the tap 56 is located at an intermediate voltage tap contact, but, after a short period, typically a few minutes, the electrodes 30 penetrate the feed material sufficiently so as to allow the tap changer 52 of the electrical supply system to be set such that the tap 56 is set to a high-voltage tap contact, also referred to as a long-arc tap. The long arc maximizes the transfer of power to the feed material and a pool of molten product develops in the furnace shell 16. Setting the tap changer 52 of the electrical supply system such that the tap 56 is set initially to a high-voltage tap contact can lead to radiation damage to the furnace shell 16.

At the start of melting, the arc is erratic and unstable, with wide swings in current being observed and accompanied by rapid movement of the electrodes 30. As the temperature of the furnace atmosphere increases, the arc stabilizes and once a molten pool is formed, the arc becomes quite stable and the average power input increases.

As the falling feed material makes contact with the surface of the molten product, the heat generated by the electrical arcs causes the feed material to be converted into at least three products, these being a gas which can contain carbon monoxide and low boiling point elements, such as zinc and phosphorous, a metallic phase, and a molten slag phase which contains silica and calcia as its major components and overlies the metallic phase. Where the feed material comprises sulphides, the feed material is converted into a further molten product, known as matte, which is sandwiched between the metallic and slag phases.

When the bowl of the furnace shell 16 is full, the feeding of feed material into the furnace shell 16 is stopped and the electrode assembly 18 is raised such that the electrodes 30 of the electrode units 22a-c are removed from the furnace shell 16.

The slag phase is then removed from the furnace shell 16 by tipping the bowl of the furnace shell 16, such that the slag phase is poured into a ladle. Where the bowl of the furnace shell 16 also includes a matte phase, as generated from the use of sulphides, the matte phase is poured into a separate ladle.

Following the removal of the slag phase and any matte phase, the furnace shell 16 is then returned to the upright position, and the procedure repeated by the introduction of additional feed material.

After repeatedly charging the bowl of the furnace shell 16 and removing the generated slag phase and any matte phase, typically in up to eight cycles, the bowl of the furnace shell 16 becomes full of the desired metallic phase.

The furnace shell 16 is then tapped to pour off the molten metallic phase into a ladle. This tapping of the molten metallic phase is achieved by tilting the furnace bowl through an angle of just over 90 degrees from the upright position.

Following tapping of the molten metallic phase, the furnace shell 16 is tilted back to its upright position for use with a new charge of material. During this period, the electrodes 30 and the furnace shell 16 are inspected for refractory damage, and, if necessary, repairs are made.

In one embodiment, when metallic fines, such as ferrochromium, ferromanganese and ferrovanadium constitute the feed material, the resulting molten metallic phase is refined, such that certain elements, for example, zinc, phosphorus, sulphur, aluminium, silicon and carbon, as well as dissolved gases, such as oxygen, are substantially removed from the resulting molten metallic phase.

### EXAMPLE

The present invention will now be described by way of example with reference to the following non-limiting Example.

In this Example, the arc furnace 12 is a 2.5 MVA furnace which has a full load rated voltage of 207 V and a full load rated current of 7200 A, and was used to smelt a mixture of chromite sand, containing 38 wt % Cr₂O₃, and silicon carbide fines.

In this Example, the furnace transformer 24 has a rated secondary current value of 7500 A, and the PLC 80 has a count range of 4000. Following Equation (4), the initial set point value is determined as follows.

nₗ=(7200/7500)*(4000/2)
nₗ=1920

Where the total electrical energy Eₜ required to drive the smelting operation is 1225 kWh/t of Cr₂O₃, and the liquidus Tₘ of the slag is 1415° C., then following Equation (5), the system-dependent factor k is determined as follows.

k=Int(((1415+273)*(1225/1000))/100)*100
k=2000

For a system-dependent factor k of 2000, the rate factor r is determined in accordance with Equation (1). FIG. 3 illustrates a plot of the rate factor r as a function of the measured values of current.

Following Equation (6) and for a voltage scaling factor l of 10, the PLC 80 is operative to provide for a drive voltage v in the range of from 0 to +10 volts or 0 to −10 volts, which, in this Example, is the quantitative signal required to drive the drive unit 40 of the supporting unit 26 to move the electrode assembly 18 one of vertically upwards or downwards.

Table I illustrates a set of parameters for a range of measured values of current, which include the representative value of current p as determined by the PLC 80, the deviation x between the set point value n and the representative value of current p, the rate factor r, the drive voltage v corresponding to the rate factor r, and the speed of movement s corresponding to the drive voltage v.

TABLE 1

| | | | | | | Electrode Speed: |
|---|---|---|---|---|---|---|
| Voltage | Current | PLC Value | | | | down (+) or up (−) |
| (V) | (A) | p | Deviation x | Rate Factor r | Drive Voltage v | (mm/s) |
| 207 | 0 | 0 | 1920 | 1843 | 9.22 | 114 |
| 207 | 720 | 192 | 1728 | 1493 | 7.46 | 92 |
| 207 | 1440 | 384 | 1536 | 1180 | 5.90 | 73 |
| 207 | 2160 | 576 | 1344 | 903 | 4.52 | 56 |
| 207 | 2880 | 768 | 1152 | 664 | 3.32 | 41 |
| 207 | 3600 | 960 | 960 | 461 | 2.30 | 29 |
| 207 | 4320 | 1152 | 768 | 295 | 1.47 | 18 |
| 207 | 5040 | 1344 | 576 | 166 | 0.83 | 10 |
| 207 | 5760 | 1536 | 384 | 74 | 0.37 | 5 |
| 207 | 6480 | 1728 | 192 | 18 | 0.09 | 1 |
| 207 | 7200 | 1920 | 0 | 0 | 0.00 | 0 |
| 207 | 8330 | 2221 | −301 | 45 | −0.23 | −3 |
| 207 | 8490 | 2264 | −344 | 59 | −0.30 | −4 |
| 207 | 9360 | 2496 | −576 | 166 | −0.83 | −10 |
| 207 | 9990 | 2664 | −744 | 277 | −1.38 | −17 |
| 207 | 11000 | 2933 | −1013 | 513 | −2.57 | −32 |
| 207 | 11420 | 3045 | −1125 | 633 | −3.17 | −39 |
| 207 | 12220 | 3259 | −1339 | 896 | −4.48 | −55 |
| 207 | 13100 | 3493 | −1573 | 1238 | −6.19 | −77 |
| 207 | 13500 | 3600 | −1680 | 1411 | −7.06 | −87 |
| 207 | 13990 | 3731 | −1811 | 1639 | −8.20 | −101 |

Finally, it will be understood that the present invention has been described in its preferred embodiment and can be modified in many different ways without departing from the scope of the invention as defined by the appended claims.

1. A control system for controlling a vertical position of at least one electrode of an arc furnace, where the arc furnace comprises a furnace transformer having a primary, input side and a secondary, output side which is electrically connected to the at least one electrode, the control system comprising:
at least one current-measuring device for measuring a current as drawn by the arc furnace;
a voltage-measuring device for measuring a voltage as applied across the arc furnace; and
a control unit for dynamically determining a setpoint for the vertical position of the at least one electrode based on the measured values of current and voltage, and providing an actuating output for driving a lifting arrangement to adjust the vertical position of the at least one electrode so as to follow the dynamically-determined setpoint, wherein the control unit comprises a processor for running a control algorithm for dynamically determining a rate factor r, where r=x²/k. with x being a deviation in a setpoint value and k being a system-dependent constant, and providing the actuating output based on the dynamically-determined rate factor r.

2. The control system of claim 1, wherein the at least one current-measuring device is operative to measure the current on one or both of the input and output sides of the furnace transformer.

3. The control system of claim 2, wherein the at least one current-measuring device comprises a first current-measuring device for measuring the current on the input side of the furnace transformer and a second current-measuring device for measuring the current on the output side of the furnace transformer.

4. The control system of claim 1, wherein the voltage-measuring device is operative to measure the voltage between a bus of the furnace transformer and a furnace hearth.

5. (canceled)

6. The control system of claim 1, wherein x=n−p and p=(a/b)*(c/2), with n being a set point value, a being the current value as measured by the at least one current-measuring device, b being a rated secondary current value of the furnace transformer, and c being a count range of the processor.

7. The control system of claim 1, wherein k=Int((Tₘ*Eₜ/1000)/100)*100, with Tₘ being the melting point (liquidus) of the slag in degrees Kelvin and Eₜ being the total electrical energy required to drive the arc furnace in terms of kWh per metric ton of a charged material.

8. The control system of claim 1, wherein the processor is operative to provide a drive voltage v as the actuating output for driving the lifting arrangement.

9. The control system of claim 8, wherein v=(r/k)*(ABS(x)/x)*l, with l being a scale voltage for a drive unit of the lifting arrangement.

10. The control system of claim 9, wherein the processor is a programmable logic controller (PLC).

11. An arc furnace comprising the control system of claim 1.

12. The arc furnace of claim 11, where used in the smelting of materials, such as ore fines, or the melting of materials, such as metallic fines.

13. A method of controlling a vertical position of at least one electrode of an arc furnace, where the arc furnace comprises a furnace transformer having a primary, input side and a secondary, output side which is electrically connected to the at least one electrode, the method comprising the steps of:
measuring at least one current as drawn by the arc furnace;
measuring a voltage as applied across the arc furnace;
dynamically determining a setpoint for the vertical position of the at least one electrode based on the measured values of current and voltage, wherein a rate factor r is dynamically determined, where r=x²/k, with x being a deviation in a setpoint value and k being a system-dependent constant; and
providing an actuating output based on the dynamically-determined rate factor r for driving a lifting arrangement to adjust the vertical position of the at least one electrode so as to follow the dynamically-determined setpoint.

14. The method of claim 13, wherein the current measuring step comprises the step of:
measuring a current on one or both of the input and output sides of the furnace transformer.

15. The method of claim 14, where the current measuring step comprises the steps of:
measuring the current on the input side of the furnace transformer; and
measuring the current on the output side of the furnace transformer.

16. The method of claim 13, wherein the voltage measuring step comprises the step of:
measuring a voltage between a bus of the furnace transformer and a furnace hearth.

17. (canceled)

18. The method of claim 13, wherein x=n−p and p=(a/b)*(c/2), with n being a set point value, a being the current value as measured by the at least one current-measuring device, b being a rated secondary current value of the furnace transformer, and c being a count range of the processor.

19. The method of claim 13, wherein k=Int((Tₘ*Eₜ/1000)/100)*100, with Tₘ being the melting point (liquidus) of the slag in degrees Kelvin and Eₜ being the total electrical energy required to drive the arc furnace in terms of kWh per metric ton of a charged material.

20. The method of claim 13, wherein the actuating output providing step comprises the step of:
providing a drive voltage v as an actuating output for driving a lifting arrangement to adjust the vertical position of the at least one electrode so as to follow the dynamically-determined setpoint.

21. The method of claim 20, wherein v=(r/k)*(ABS(x)/x)*l, with l being a scale voltage for a drive unit of the lifting arrangement.

22. The method of claim 13, where used in the smelting of materials, such as ore fines, or the melting of materials, such as metallic fines.
